(19) United States
(12) Patent Application Publication
(10) Pub. No.: US 2024/0088436 A1
(43) Pub. Date: Mar. 14, 2024

(54) SOLID ELECTROLYTE MATERIAL AND BATTERY USING THE SAME

(71) Applicant: Panasonic Intellectual Property Management Co., Ltd., Osaka (JP)

(72) Inventors: TOMOYASU YOKOYAMA, Osaka (JP); KOSEI OHURA, Osaka (JP); TAKUYA NARUSE, Osaka (JP)

(21) Appl. No.: 18/513,661

(22) Filed: Nov. 20, 2023

Related U.S. Application Data
(63) Continuation of application No. PCT/JP2022/016860, filed on Mar. 31, 2022.

(30) Foreign Application Priority Data
Jun. 2, 2021 (JP) 2021-092758

(51) Int. Cl. H01M 10/0562

(52) U.S. Cl. CPC H01M 10/0562; H01M 10/052

(57) ABSTRACT

The solid electrolyte material of the present disclosure comprises lithium and a plurality of anion elements. The plurality of anion elements includes antimony and at least one element selected from the group consisting of pnictogen elements excluding antimony, chalcogen elements, and halogen elements. The battery of the present disclosure comprises a positive electrode, a negative electrode, and an electrolyte layer disposed between the positive electrode and the negative electrode, wherein at least one selected from the group consisting of the positive electrode, the negative electrode, and the electrolyte layer contains the solid electrolyte material of the present disclosure.

### BACKGROUND

### 1. Technical Field

The present disclosure relates to a solid electrolyte material and a battery using it.

### 2. Description of the Related Art

T. Kimura et al. Solid State Ionics, 333 (2019), 45-49 discloses Li₃SbS₄ as a solid electrolyte including cationic antimony.

### SUMMARY

One non-limiting and exemplary embodiment provides a new solid electrolyte material having a lithium ion conductivity.

In one general aspect, the techniques disclosed here feature a solid electrolyte material comprising lithium and a plurality of anion elements, wherein the plurality of anion elements includes antimony and at least one element selected from the group consisting of pnictogen elements excluding antimony, chalcogen elements, and halogen elements.

The present disclosure can provide a new solid electrolyte material having a lithium ion conductivity.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 shows a cross-sectional view of a battery 1000 according to a second embodiment;

FIG. 2 shows a schematic view of a compression molding dies 300 that is used for evaluating the ion conductivity of a solid electrolyte material;

FIG. 3 is a graph showing a cole-cole plot obtained by impedance measurement of a solid electrolyte material of Example 4; and

FIG. 4 is a graph showing the initial charge and discharge characteristics of a battery of Example 2.

### DETAILED DESCRIPTIONS

Embodiments of the present disclosure will now be described with reference to the drawings.

### First Embodiment

The solid electrolyte material of the present embodiment comprises lithium and a plurality of anion elements. The plurality of anion elements includes antimony and at least one element selected from the group consisting of pnictogen elements excluding antimony, chalcogen elements, and halogen elements,

The solid electrolyte material is a solid electrolyte material that is suitable for improving lithium ion conductivity. The solid electrolyte material has, for example, a high lithium ion conductivity. Accordingly, the solid electrolyte material can be used for obtaining a battery having excellent charge and discharge characteristics. An example of the battery is an all-solid-state secondary battery.

Here, an example of the high lithium ion conductivity is, for example, greater than or equal to 6.3×10⁻⁵ S/cm at around room temperature. The solid electrolyte material can have an ion conductivity of, for example, greater than or equal to 6.3×10⁻⁵ S/cm. The room temperature is, for example, 25° C.

Antimony has an electronegativity lower than those of chalcogen elements (i.e., the group 16 elements), halogen elements (i.e., the group 17 elements), and nitrogen. When antimony is used as an anion, the interaction between the anion and lithium is weakened, and the ion conductivity of the solid electrolyte material is improved.

The term “anion” means a more negatively charged state compared to the simple metal. An example of anionic antimony is trivalent negatively charged Sb³⁻. Thus, the solid electrolyte material of the present embodiment includes negatively charged antimony.

One example of the method for judging whether an element is an anion or not is XPS measurement (X-ray photoelectron spectroscopy measurement). When the binding energy determined by XPS measurement is smaller than that of the simple metal, the element to be measured is negatively charged, and it is possible to determine the element to be measured as an anion.

The solid electrolyte material may contain an element that is unavoidably mixed. An example of the element is hydrogen. The element may be present in the raw material powders of the solid electrolyte material or in the atmosphere for manufacturing or storing the solid electrolyte material. The amount of the element unavoidably mixed in the solid electrolyte material is, for example, less than or equal to 1 mol %.

In the present disclosure, pnictogen elements mean nitrogen, phosphorus, arsenic, and antimony; chalcogen elements mean oxygen, sulfur, selenium, and tellurium; and halogen elements mean fluorine, chlorine, bromine, and iodine.

The solid electrolyte material may consist of lithium, antimony, and a pnictogen element.

The fact that “consisting of lithium, antimony, and a pnictogen element” means that no other elements are intentionally added, except for inevitable impurities. For example, the molar proportion (i.e., molar fraction) of the total amount of lithium, antimony, and a pnictogen element to the total amount of all elements constituting the solid electrolyte material is greater than or equal to 95%. This also applies to when the pnictogen element is replaced by a chalcogen element or a halogen element.

The solid electrolyte material may be a material represented by the following Formula (1):

Li₃SbₓPn₁₋ₓ (1).

Here, 0<x<1 is satisfied. Pn is at least one selected from the group consisting of N, P, and As. The solid electrolyte material represented by Formula (1) has a high ion conductivity.

In order to enhance the ion conductivity of the solid electrolyte material, in Formula (1), 0.01≤x≤0.9 may be satisfied, or 0.2≤x≤0.8 may be satisfied.

The solid electrolyte material may consist of lithium, antimony, and a chalcogen element.

The solid electrolyte material may be a material represented by the following Formula (2):

Li_{2+y}Sb_{y}Ch_{1-y} (2).

Here, 0<y<1 is satisfied. Ch is at least one selected from the group consisting of O, S, Se, and Te. The solid electrolyte material represented by Formula (2) has a high ion conductivity.

In order to enhance the ion conductivity of the solid electrolyte material, in Formula (2), Ch may include Te. In Formula (2), Ch may be Te.

In order to enhance the ion conductivity of the solid electrolyte material, in Formula (2), 0.01≤y≤0.9 may be satisfied, or 0.2≤y≤0.8 may be satisfied.

The solid electrolyte material may consist of lithium, antimony, and a halogen element.

The solid electrolyte material may be a material represented by the following Formula (3):

Li_{1+2z}Sb_{z}Hal_{1-z} (3).

Here, 0<z<1 is satisfied. Hal is at least one selected from the group consisting of F, Cl, Br, and I. The solid electrolyte material represented by Formula (3) has a high ion conductivity.

In order to enhance the ion conductivity of the solid electrolyte material, in Formula (3), Hal may include I. In Formula (3), Hal may be I.

In order to enhance the ion conductivity of the solid electrolyte material, in Formula (3), 0.01≤z≤0.9 may be satisfied, or 0.2≤z≤0.8 may be satisfied.

The solid electrolyte material may be crystalline or amorphous.

The shape of the solid electrolyte material is not limited. Examples of the shape are needle, spherical, and oval spherical shapes. The solid electrolyte material may be a particle. The solid electrolyte material may have a pallet or planar shape.

When the shape of the solid electrolyte material is particulate (e.g., spherical), the solid electrolyte material may have a median diameter of greater than or equal to 0.1 μm and less than or equal to 100 μm or may have a median diameter of greater than or equal to 0.5 μm and less than or equal to 10 μm. Consequently, the solid electrolyte material and another material can be well dispersed. The median diameter of a particle means the particle diameter at which the accumulated deposition is 50% in a volume-based particle size distribution. The volume-based particle size distribution is measured with, for example, a laser diffraction measurement apparatus or an image analyzer. Method for manufacturing solid electrolyte material

The solid electrolyte material is manufactured by, for example, the following method.

For example, raw material powders of antimonides are mixed so as to five a target composition.

As an example, when the target composition is Li_{2.2}Sb_{0.2}Te_{0.8}, a Li₃Sb raw material powder and a Li₂Te raw material powder are mixed at a molar ratio of Li₃Sb:Li₂Te of about 0.2:0.8. The raw material powders may be mixed at a molar ratio adjusted in advance so as to offset a composition change that may occur in the synthesis process.

The values of x, y, and z in Formulae (1) to (3) are increased by increasing the amount of Li₃Sb.

As the raw materials, a Li-metal or an Sb-metal may be used.

Raw material powders in a mixture form are mechanochemically reacted with each other in a mixing apparatus such as a planetary ball mill to obtain a reaction product. That is, raw material powders are reacted with each other by a mechanochemical milling method. The reaction product may be heat-treated in vacuum or in an inert atmosphere. Alternatively, a mixture of the raw material powders may be heat-treated in vacuum or in an inert atmosphere to obtain a reaction product. Examples of the inert atmosphere include a helium atmosphere, an argon atmosphere, and a nitrogen atmosphere.

The solid electrolyte material according to a first embodiment is obtained by these methods.

### Second Embodiment

A second embodiment will now be described. Matters described in the first embodiment may be omitted as appropriate.

The battery according to the second embodiment comprises a positive electrode, an electrolyte layer, and a negative electrode. The electrolyte layer is disposed between the positive electrode and the negative electrode. At least one selected from the group consisting of the positive electrode, the electrolyte layer, and the negative electrode contains the solid electrolyte material according to the first embodiment.

The battery according to the second embodiment contains the solid electrolyte material according to the first embodiment and therefore has excellent charge and discharge characteristics.

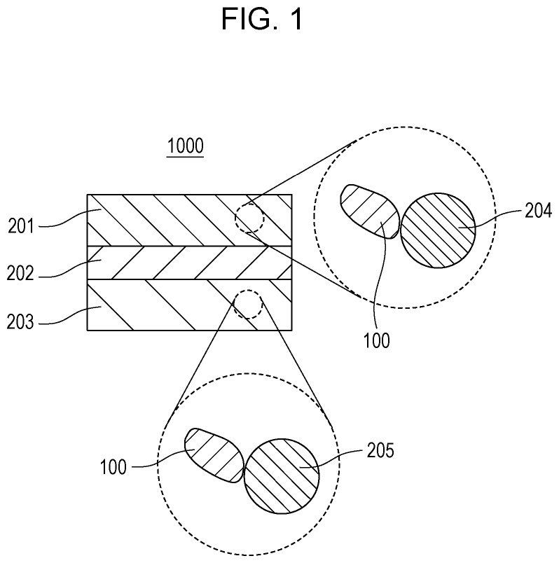

FIG. 1 shows a cross-sectional view of a battery 1000 according to the second embodiment.

The battery 1000 comprises a positive electrode 201, an electrolyte layer 202, and a negative electrode 203. The electrolyte layer 202 is disposed between the positive electrode 201 and the negative electrode 203.

The positive electrode 201 contains a positive electrode active material 204 and a solid electrolyte 100.

The negative electrode 203 contains a negative electrode active material 205 and a solid electrolyte 100.

The solid electrolyte 100 includes the solid electrolyte material according to the first embodiment. The solid electrolyte 100 may be a particle including the solid electrolyte material according to the first embodiment as a main component. The particle including the solid electrolyte material according to the first embodiment as a main component means a particle in which the component included in the largest molar ratio is the solid electrolyte material according to the first embodiment. The solid electrolyte 100 may be a particle consisting of the solid electrolyte material according to the first embodiment.

The positive electrode 201 contains a material that can occlude and release metal ions such as lithium ions. The material is, for example, the positive electrode active material 204.

Examples of the positive electrode active material are a lithium-containing transition metal oxide, a transition metal fluoride, a polyanionic material, a fluorinated polyanionic material, a transition metal sulfide, a transition metal oxyfluoride, a transition metal oxysulfide, and a transition metal oxynitride. Examples of the lithium-containing transition metal oxide are Li(Ni,Co,Mn)O₂, Li(Ni,Co,Al)O₂, and LiCoO₂.

In the present disclosure, “(A,B,C)” means “at least one selected from the group consisting of A, B, and C”.

The shape of the positive electrode active material 204 is not particularly limited. The positive electrode active material 204 may be a particle. The positive electrode active material 204 may have a median diameter of greater than or equal to 0.1 μm and less than or equal to 100 μm. When the positive electrode active material 204 has a median diameter of greater than or equal to 0.1 μm, the positive electrode active material 204 and the solid electrolyte 100 can be well dispersed in the positive electrode 201. Consequently, the charge and discharge characteristics of the battery 1000 are improved. When the positive electrode active material 204 has a median diameter of less than or equal to 100 μm, the lithium diffusion speed in the positive electrode active material 204 is improved. Consequently, the battery 1000 can operate at a high output.

The positive electrode active material 204 may have a median diameter larger than that of the solid electrolyte 100. Consequently, the positive electrode active material 204 and the solid electrolyte 100 can be well dispersed.

In order to increase the energy density and the output of the battery 1000, in the positive electrode 201, the ratio of the volume of the positive electrode active material 204 to the sum of the volume of the positive electrode active material 204 and the volume of the solid electrolyte 100 may be greater than or equal to 0.30 and less than or equal to 0.95.

In order to increase the energy density and the output of the battery 1000, the positive electrode 201 may have a thickness of greater than or equal to 10 μm and less than or equal to 500 μm.

The electrolyte layer 202 contains an electrolyte material. The electrolyte material is, for example, a solid electrolyte material. The electrolyte layer 202 may be a solid electrolyte layer. The electrolyte layer 202 may contain the solid electrolyte material according to the first embodiment.

The electrolyte layer 202 may contain greater than or equal to 50 mass % of the solid electrolyte material according to the first embodiment. The electrolyte layer 202 may contain greater than or equal to 70 mass % of the solid electrolyte material according to the first embodiment. The electrolyte layer 202 may contain greater than or equal to 90 mass % of the solid electrolyte material according to the first embodiment. The electrolyte layer 202 may consist of the solid electrolyte material according to the first embodiment only.

Hereinafter, the solid electrolyte material according to the first embodiment is referred to as first solid electrolyte material. A solid electrolyte material different from the first solid electrolyte material is referred to as second solid electrolyte material.

The electrolyte layer 202 may contain not only the first solid electrolyte material but also the second solid electrolyte material. The first solid electrolyte material and the second solid electrolyte material may be uniformly dispersed in the electrolyte layer 202. A layer made of the first solid electrolyte material and a layer made of the second solid electrolyte material may be stacked along the stacking direction of the battery 1000.

The electrolyte layer 202 may consist of the second solid electrolyte material only.

The electrolyte layer 202 may have a thickness of greater than or equal to 1 μm and less than or equal to 1000 μm. When the electrolyte layer 202 has a thickness of greater than or equal to 1 μm, the positive electrode 201 and the negative electrode 203 are unlikely to be short-circuited. When the electrolyte layer 202 has a thickness of less than or equal to 1000 μm, the battery 1000 can operate at a high output.

The negative electrode 203 contains a material that can occlude and release metal ions such as lithium ions. The material is, for example, a negative electrode active material 205.

Examples of the negative electrode active material 205 are a metal material, a carbon material, an oxide, a nitride, a tin compound, and a silicon compound. The metal material may be a single metal or an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material 205 are silicon (i.e., Si), tin (i.e., Sn), a silicon compound, and a tin compound.

The shape of the negative electrode active material 205 is not limited to a specific shape. The negative electrode active material 205 may be a particle. The negative electrode active material 205 may have a median diameter of greater than or equal to 0.1 μm and less than or equal to 100 μm. When the negative electrode active material 205 has a median diameter of greater than or equal to 0.1 μm, the negative electrode active material 205 and the solid electrolyte 100 can be well dispersed in the negative electrode 203. Consequently, the charge and discharge characteristics of the battery 1000 are improved. When the negative electrode active material 205 has a median diameter of less than or equal to 100 μm, the lithium diffusion speed in the negative electrode active material 205 is improved. Consequently, the battery 1000 can operate at a high output.

The negative electrode active material 205 may have a median diameter larger than that of the solid electrolyte 100. Consequently, the negative electrode active material 205 and the solid electrolyte 100 can be well dispersed.

In order to increase the energy density and the output of the battery 1000, in the negative electrode 203, the ratio of the volume of the negative electrode active material 205 to the sum of the volume of the negative electrode active material 205 and the volume of the solid electrolyte 100 may be greater than or equal to 0.30 and less than or equal to 0.95.

In order to increase the energy density and the output of the battery 1000, the negative electrode 203 may have a thickness of greater than or equal to 10 μm and less than or equal to 500 μm.

At least one selected from the group consisting of the positive electrode 201, the electrolyte layer 202, and the negative electrode 203 may contain the second solid electrolyte material for the purpose of enhancing the ion conductivity, chemical stability, and electrochemical stability.

The second solid electrolyte material may be a halide solid electrolyte.

Examples of the halide solid electrolyte include Li₂MgX′₄, Li₂FeX′₄, Li(Al,Ga,In)X′₄, and Li₃(Al,Ga,In)X′₆. Here, X′ is at least one selected from the group consisting of F, Cl, Br, and I.

Other examples of the halide solid electrolyte are compounds represented by LiₚMe_{q}YᵣZ₆. Here, p+m′q+3r=6 and r>0 are satisfied. Me is at least one element selected from the group consisting of metal elements excluding Li and Y and metalloid elements. Z is at least one selected from the group consisting of F, Cl, Br, and I. The value of m′ represents the valence of Me. The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded). From the viewpoint of the ion conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

The second solid electrolyte material may be a sulfide solid electrolyte.

Examples of the sulfide solid electrolyte are Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

The second solid electrolyte material may be an oxide solid electrolyte. Examples of the oxide solid electrolyte are:
(i) an NASICON-type solid electrolyte, such as LiTi₂(PO₄)₃ or its element substitute;
(ii) a perovskite-type solid electrolyte, such as (LaLi)TiO₃;
(iii) an LISICON-type solid electrolyte, such as Li₁₄ZnGe₄O₁₆, Li₄SiO₄, LiGeO₄, or its element substitute;
(iv) a garnet-type solid electrolyte, such as Li₇La₃Zr₂O₁₂ or its element substitute; and
(v) Li₃PO₄ or its N-substitute.

The second solid electrolyte material may be an organic polymeric solid electrolyte.

Examples of the organic polymeric solid electrolyte are a polymeric compound and a compound of a lithium salt. The polymeric compound may have an ethylene oxide structure. A polymeric compound having an ethylene oxide structure can contain a large amount of a lithium salt and can therefore further enhance the ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte solution, a gel electrolyte, or an ionic liquid for the purpose of facilitating the transfer of lithium ions and improving the output characteristics of the battery.

The nonaqueous electrolyte solution includes a nonaqueous solvent and a lithium salt dissolved in the nonaqueous solvent.

Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, greater than or equal to 0.5 mol/L and less than or equal to 2 mol/L.

As the gel electrolyte, a polymer material impregnated with a nonaqueous electrolyte solution can be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium and tetraalkylphosphonium;
(ii) aliphatic cyclic ammonium, such as pyrrolidiniums, morpholiniums, imidazoliniums, tetrahydropyrimidiniums, piperaziniums, and piperidiniums; and
(iii) a nitrogen-containing heterocyclic aromatic cation, such as pyridiniums and imidazoliums.

Examples of the anion included in the ionic liquid are PF₆, BF₄, SbF₆, AsF₆, SO₃CF₃, N(SO₂CF₃)₂, N(SO₂C₂F₅)₂, N(SO₂CF₃)(SO₂C₄F₉), and C(SO₂CF₃)₃.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer can also be used as the binder. Examples of such a binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above-mentioned materials may be used as the binder.

At least one selected from the group consisting of the positive electrode 201 and the negative electrode 203 may contain a conductive assistant for the purpose of enhancing the electron conductivity.

Examples of the conductive assistant are:
(i) graphite, such as natural graphite and artificial graphite;
(ii) carbon black, such as acetylene black and Ketjen black;
(iii) conductive fibers, such as carbon fibers and metal fibers;
(iv) carbon fluoride;
(v) metal powders, such as aluminum;
(vi) conductive whiskers, such as zinc oxide and potassium titanate;
(vii) a conductive metal oxide, such as titanium oxide; and
(viii) a conductive polymer compound, such as polyanion, polypyrrole, and polythiophene. In order to reduce the cost, the conductive assistant of the above (i) or (ii) may be used.

Examples of the shape of the battery according to the second embodiment are coin type, cylindrical type, square type, sheet type, button type, flat type, and stacked type.

### EXAMPLES

The present disclosure will now be described in more detail with reference to Examples.

### Example 1

### Production of Raw Material

Li and Sb were provided as raw material powders at a molar ratio of Li:Sb=3.5:1 in an argon atmosphere having a dew point of less than or equal to −60° C. (hereinafter, referred to as “dry argon atmosphere”). These raw material powders were pulverized and mixed in a mortar. Thus, a powder mixture was obtained. The powder mixture was heat-treated at 650° C. for 1 hour in a dry argon atmosphere. The obtained powder was pulverized in a mortar to obtain a powder of Li₃Sb.

Subsequently, Li and Te were provided as raw material powders at a molar ratio of Li:Te=2.5:1 in a dry argon atmosphere. These raw material powders were pulverized and mixed in a mortar. Thus, a powder mixture was obtained. The powder mixture was heat-treated at 500° C. for 1 hour in a dry argon atmosphere. The obtained powder was pulverized in a mortar to obtain a powder of Li₂Te.

Subsequently, Li and Se were provided as raw material powders at a molar ratio of Li:Se=2.5:1 in a dry argon atmosphere. These raw material powders were pulverized and mixed in a mortar. Thus, a powder mixture was obtained. The powder mixture was heat-treated at 500° C. for 1 hour in a dry argon atmosphere. The obtained powder was pulverized in a mortar to obtain a powder of Li₂Se.

### Production of Solid Electrolyte Material

Li₃Sb and Li₂Te were provided as raw material powders at a molar ratio of Li₃Sb:Li₂Te=2:8 in a dry argon atmosphere. These raw material powders were pulverized and mixed in a mortar. Thus, a powder mixture was obtained. The powder mixture was subjected to milling treatment with a planetary ball mill at 500 rpm for 12 hours. Thus, a powder of the solid electrolyte material of Example 1 was obtained. The solid electrolyte material of Example 1 had a composition represented by Li_{2.2}Sb_{0.2}Te_{0.8}.

The contents of Li, Sb, and Te per unit weight of the solid electrolyte material of Example 1 were measured by an XPS measurement method. The Li:Sb:Te molar ratio was calculated based on the contents of Li, Sb, and Te obtained from these measurement results. As a result, the solid electrolyte material of Example 1 had a molar ratio of Li:Sb:Te=2.2:0.2:0.8 as with the molar ratio of the raw material powders.

### Evaluation of Ion Conductivity

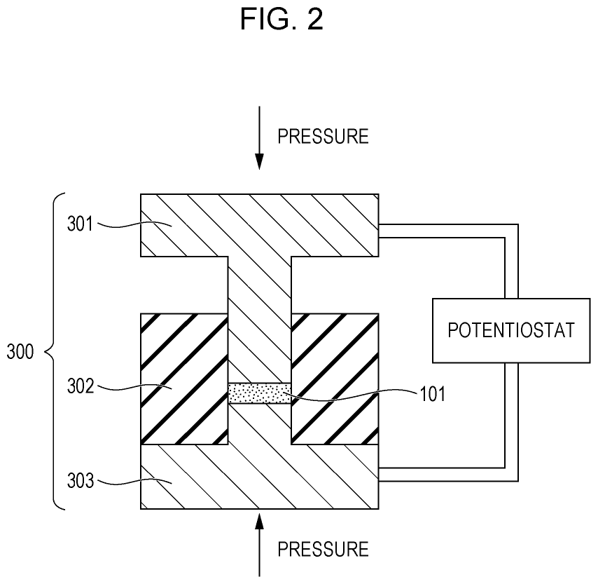

FIG. 2 is a schematic view showing a compression molding dies 300 used for evaluation of the ion conductivity of a solid electrolyte material.

The compression molding dies 300 included a punch upper part 301, a die 302, and a punch lower part 303. The punch upper part 301 and the punch lower part 303 were both formed from electron-conductive stainless steel. The die 302 was formed from insulating polycarbonate.

The ion conductivity of the solid electrolyte material of Example 1 was measured using the compression molding dies 300 shown in FIG. 2 by the following method.

The powder of the solid electrolyte material of Example 1 (i.e., the powder 101 of the solid electrolyte material in FIG. 2) was loaded inside the compression molding dies 300 in a dry atmosphere having a dew point of less than or equal to −30° C. A pressure of 300 MPa was applied to the powder 101 of the solid electrolyte material of Example 1 inside the compression molding dies 300 using the punch upper part 301 and the punch lower part 303.

The punch upper part 301 and the punch lower part 303 were connected to a potentiostat (Princeton Applied Research, VersaSTAT4) equipped with a frequency response analyzer under application of the pressure. The punch upper part 301 was connected to the working electrode and the potential measurement terminal. The punch lower part 303 was connected to the counter electrode and the reference electrode. The impedance of a solid electrolyte material was measured by an electrochemical impedance measurement method at room temperature.

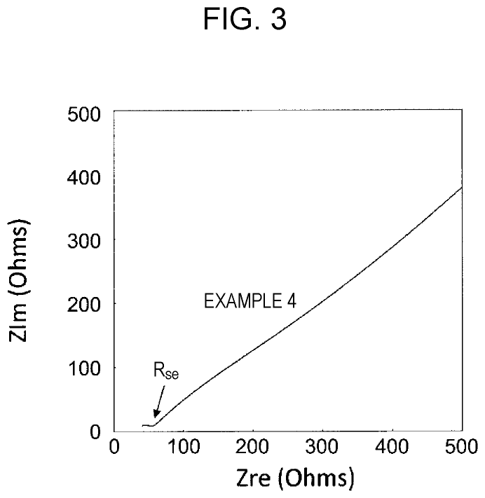

FIG. 3 is a graph showing a cole-cole plot obtained by impedance measurement of the solid electrolyte material of Example 4.

In FIG. 3, the real value of impedance at the measurement point where the absolute value of the phase of complex impedance was the smallest was regarded as the resistance value to ionic conduction of the solid electrolyte material. Regarding the real value, see the arrow Rₛₑ shown in FIG. 3. The ion conductivity was calculated using the resistance value based on the following mathematical expression (4):

σ=(Rₛₑ×S/t)⁻¹ (4).

Here, σ represents ion conductivity; S represents the contact area of a solid electrolyte material with the punch upper part 301, i.e., S is equal to the cross-sectional area of the hollow part of the die 302 in FIG. 2; Rₛₑ represents the resistance value of the solid electrolyte material in impedance measurement; and t represents the thickness of the solid electrolyte material, i.e., t represents the thickness of the layer formed from the powder 101 of the solid electrolyte material in FIG. 2.

The ion conductivity of the solid electrolyte material of Example 1 measured at 22° C. was 6.3×10⁻⁵ S/cm.

### Production of Battery

The solid electrolyte material of Example 1 and graphite were provided at a volume ratio of 1:1 in a dry argon atmosphere. These materials were mixed in a mortar. Thus, a mixture was obtained.

An argyrodite-type sulfide solid electrolyte Li₆PS₅Cl (80 mg), the solid electrolyte material (30 mg) of Example 1, and the above mixture were stacked in this order in an insulating tube having an inner diameter of 9.5 mm. The amount of the mixture was an amount including 4 mg of graphite. A pressure of 740 MPa was applied to this stack to form a solid electrolyte layer and a first electrode.

Subsequently, metal Li foil was stacked on the solid electrolyte layer. A pressure of 40 MPa was applied to this stack to form a second electrode.

Subsequently, a current collector formed from stainless steel was attached to the first electrode and the second electrode, and a current collecting lead was attached to the current collector.

Finally, the inside of the insulating tube was isolated from the outside atmosphere using an insulating ferrule to seal the inside of the tube. Thus, a battery of Example 1 was obtained.

### Initial Charge and Discharge Test

The initial charge and discharge characteristics were measured by the following method.

The battery of Example 1 was placed in a thermostat of 25° C.

The battery of Example 1 was charged at a current density of 74.5 μA/cm² until the voltage reached 0 V. This current density corresponded to 0.05 C rate.

Subsequently, the battery of Example 1 was discharged at a current density of 74.5 μA/cm² until the voltage reached 0.5 V.

As the results of the charge and discharge test, the battery of Example 1 had an initial discharge capacity of 229 mAh/g.

### Examples 2 to 9

### Production of Solid Electrolyte Material

In Examples 2 to 6, as raw material powders, Li₃Sb and Li₂Te were provided at a Li₃Sb:Li₂Te molar ratio of y:(1−y). The values of y are shown in Table 1.

In Example 6, after milling treatment, heat treatment was performed in a dry argon atmosphere at 400° C. for 0.5 hours.

In Example 7, as raw material powders, Li₃Sb and Li₂Se were provide at a Li₃Sb:Li₂Se molar ratio of 0.67:0.33.

In Example 8, as raw material powders, Li₃Sb and Li₂S were provided at a Li₃Sb:Li₂S molar ratio of 0.67:0.33.

In Example 9, as raw material powders, Li₃Sb and LiI were provided at a Li₃Sb:LiI molar ratio of 0.5:0.5.

Solid electrolyte materials of Examples 2 to 9 were obtained as in Example 1 except for the above matters. The values of y and z are shown in Table 1.

### Evaluation of Ion Conductivity

The ion conductivities of the solid electrolyte materials of Examples 2 to 9 were measured as in Example 1. The measurement results are shown in Table 1.

### Charge and Discharge Test

Batteries of Examples 2 to 9 were obtained as in Example 1 using the solid electrolyte materials of Examples 2 to 9. The batteries of Examples 2 to 9 were well charged and discharged as in the battery of Example 1.

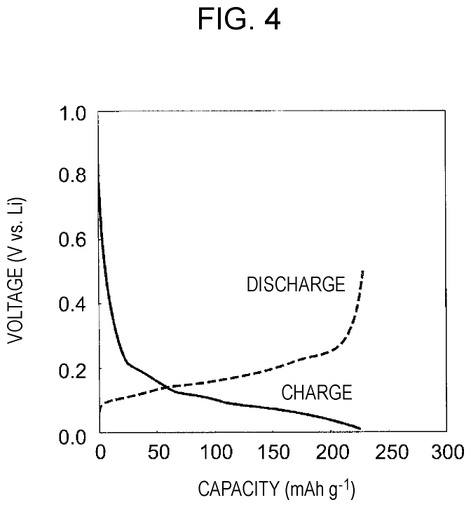

FIG. 4 is a graph showing the initial discharge characteristics of a battery of Example 2.

### Comparative Examples 1 to 4

### Production of Solid Electrolyte Material

As a solid electrolyte material of Comparative Examples 1, Li₂Te was provided.

As a solid electrolyte material of Comparative Example 2, Li₂Se was provided.

As a solid electrolyte material of Comparative Example 3, Li₂S was provided.

As a solid electrolyte material of Comparative Example 4, LiI was provided.

### Evaluation of Ion Conductivity

The ion conductivities of the solid electrolyte materials of Comparative Examples 1 to 4 were measured as in Example 1. The measurement results are shown in Table 1.

TABLE 1

| | | | Ion conductivity |
|---|---|---|---|
| | Composition | y or z | (S/cm) |
| Example 1 | Li_{2.2}Sb_{0.2}Te_{0.8} | 0.2 | 6.3 × 10⁻⁵ |
| Example 2 | Li_{2.33}Sb_{0.33}Te_{0.67} | 0.33 | 2.2 × 10⁻⁴ |
| Example 3 | Li_{2.5}Sb_{0.5}Te_{0.5} | 0.5 | 7.6 × 10⁻⁴ |
| Example 4 | Li_{2.67}Sb_{0.67}Te_{0.33} | 0.67 | 1.3 × 10⁻³ |
| Example 5 | Li_{2.8}Sb_{0.8}Te_{0.2} | 0.8 | 1.4 × 10⁻³ |
| Example 6 | Li_{2.8}Sb_{0.8}Te_{0.2} | 0.8 | 3.5 × 10⁻³ |
| Example 7 | Li_{2.67}Sb_{0.67}Se_{0.33} | 0.67 | 1.5 × 10⁻⁴ |
| Example 8 | Li_{2.67}Sb_{0.67}S_{0.33} | 0.67 | 1.9 × 10⁻⁴ |
| Example 9 | Li₂Sb_{0.5}I_{0.5} | 0.5 | 5.5 × 10⁻⁴ |
| Comparative | Li₂Te | — | 4.0 × 10⁻⁷ |
| Example 1 | | | |
| Comparative | Li₂Se | — | 6.0 × 10⁻⁷ |
| Example 2 | | | |
| Comparative | Li₂S | — | 1.0 × 10⁻⁶ |
| Example 3 | | | |
| Comparative | LiI | — | 3.2 × 10⁻⁶ |
| Example 4 | | | |

### Consideration

In Table 1, the item “y or z” represents the value of y in Formula (2) or the value of z in Formula (3). As obvious from Table 1, the solid electrolyte materials of Examples 1 to 9 have a high ion conductivity of greater than or equal to 6.3×10⁻⁵ S/cm at around room temperature. Accordingly, a solid electrolyte material containing lithium and anionic antimony has a high ion conductivity.

In all of Examples 1 to 9, the batteries were charged and discharged at room temperature.

Even if a pnictogen element other than antimony, such as N, P, As, or Bi, is used, an ion conductivity of the example level can be achieved. The chemical and electrical properties of these elements are highly similar to antimony, and a part of antimony can be substituted with these elements.

As described above, the solid electrolyte material of the present disclosure is a material that can improve lithium ion conductivity and is suitable for providing a battery that can be well charged and discharged.

The solid electrolyte material of the present disclosure is used in, for example, a battery (for example, an all-solid-state lithium ion secondary battery).

What is claimed is:

1. A solid electrolyte material comprising lithium and a plurality of anion elements, wherein
the plurality of anion elements include antimony and at least one element selected from the group consisting of pnictogen elements excluding antimony, chalcogen elements, and halogen elements.

2. The solid electrolyte material according to claim 1, represented by a following Formula (2):
Li_{2+y}Sb_{y}Ch_{1-y} (2)
here, 0<y<1 is satisfied, and
Ch is at least one selected from the group consisting of O, S, Se, and Te.

3. The solid electrolyte material according to claim 2, wherein
in the Formula (2), Ch includes Te.

4. The solid electrolyte material according to claim 1, represented by a following Formula (3):
Li_{1+2z}Sb_{z}Hal_{1-z} (3)
here, 0<z<1 is satisfied, and
Hal is at least one selected from the group consisting of F, Cl, Br, and I.

5. The solid electrolyte material according to claim 4, wherein
in the Formula (3), Hal includes I.

6. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer contains the solid electrolyte material according to claim 1.
